(19) United States
(12) Patent Application Publication
(10) Pub. No.: US 2010/0139790 A1
(43) Pub. Date: Jun. 10, 2010

(54) Faucet Adapted for Use by Both Humans and Pets

(76) Inventors: William Jockusch, Waltham, MA (US); Joel Mick, San Diego, CA (US); Paul Berman, Santa Monica, CA (US)

Correspondence Address: Russ Weinzimmer, 614 Nashua Street, Suite 53, Milford, NH, 03055, US

(21) Appl. No.: 12/329,576

(22) Filed: Dec. 6, 2008

(51) Int. Cl. A01K 7/06; F16K 21/00

(52) U.S. Cl. 137/560; 119/74

(57) ABSTRACT

An indoor sink faucet is claimed that is adapted for both human and pet use. The faucet substantially resembles a conventional human faucet, but includes integrated features that allow a pet to activate a flow of water and drink therefrom. Pet and human water can be dispensed from the same or separate outlets. Pet water can be mechanically activated, using for example a lever protruding from the pet water outlet. In other embodiments, the pet valve actuator uses a remote sensor to detect a pet using infra-red light, microwaves, or similar means. A timer can allow pet water to flow after actuation for a period that can be adjustable by a user. A flow sensor can prevent pet water flow when human water is flowing. And a training mode selector can cause pet water to flow continuously, thereby allowing a pet to learn how to use the faucet.

### FIELD OF THE INVENTION

The invention generally relates to plumbing fixtures, and more specifically to plumbing fixtures adapted for use by animals.

### BACKGROUND OF THE INVENTION

The overall health and comfort of a pet is generally enhanced by encouraging the pet to drink plenty of water. For pets, water is often provided in a bowl, the contents of which are changed optimally once or twice per day by a person caring for the pet. However, pet caregivers cannot always be home when the time comes to change a pet's water, and even if the caregiver is home, it is human nature to sometimes forget this task. Even if the water in a pet bowl is changed regularly, it can nevertheless become stagnant, and can gather contaminants such as dust, insects, and food particles from the muzzle of the pet. This can cause the water to lose its appeal for the pet, and result in the pet drinking less water. Pet water bowls also take up space within a dwelling, require frequent cleaning, can be accidentally spilled, and can be tripping hazards.

Indoor pet water fountains are available that circulate and filter water provided for a pet, so as to aerate the water and remove contaminants. However, this approach still requires frequent changing of the water as it grows stale and/or is consumed. This approach also requires frequent exchange of the filter element, frequent cleaning of the water fountain surfaces, takes up floor space within a residence, and can serve as a spilling and a tripping hazard.

Kits have been proposed that adapt to a conventional human water faucet, for example in a kitchen or bathroom, and enable a pet to actuate a flow of water and drink therefrom. However, this approach results in an unsightly installation that is easily knocked out of place or otherwise damaged, and can cause significant damage to existing plumbing.

### SUMMARY OF THE INVENTION

An indoor water faucet is claimed that is adapted for use by both humans and pets. The appearance of the faucet substantially resembles a conventional indoor water faucet designed strictly for human use, but includes integrated features that allow a pet, such as a cat or a dog, to activate a flow of water and drink therefrom. The faucet includes at least one conventional water valve for human use, and in preferred embodiments includes conventional hot and cold human-activated water valves. In addition, the faucet includes a pet water valve and a pet valve actuator that can be activated by a pet so as to provide a flow of cool water at a rate appropriate for allowing the pet to drink.

In some preferred embodiments, pet activated water is dispensed from a pet water outlet and human activated water is dispensed from a separate human use water outlet. In other embodiments, a common water outlet is used to dispense water for both pets and humans. In certain preferred embodiments the pet valve actuator is mechanical, using for example an activation lever that is protrudes from the center of the pet water outlet. In other embodiments the pet valve actuator includes a remote electronic sensor that detects the presence of a pet by emitting and detecting a sensing energy, such as infra-red light, microwaves, or another form of remote sensing energy. A timer can be included that allows pet water to flow for a specified amount of time after a pet is no longer detected, and in some of these embodiments the specified amount of time can be adjusted by a user. A flow sensor can be included in the human flow water channel and an electronic valve controller can prevent water from flowing out of the pet water outlet when water is flowing from the human water outlet.

Some embodiments also include a training mode selector that can be used to activate a training mode wherein water flows continuously from the pet water outlet, thereby creating an expectation in a pet that water can be obtained from the pet water outlet, and providing an opportunity for a pet to learn to drink therefrom.

The present invention is an indoor sink faucet adapted for use by both humans and pets. The faucet includes the following elements:

a spout;

a human use water outlet integral with the spout;

a pet water outlet integral with the spout;

a human use water valve, the human use water valve being:
connected to the human use water outlet;
connectable to a source of water; and
able to be activated by a human user so as to provide a flow of water from the human use water outlet;

a pet water valve, the pet water valve being:
connected to the pet water outlet;
connectable to the source of water; and
able to be activated so as to provide a flow of water from the pet water outlet; and

a pet valve actuator cooperative with the pet water valve and configured so as to enable actuation of the pet water valve by a pet.

In preferred embodiments the flow of water from the human use water outlet and the flow of water from the pet water outlet emerge from a common outlet. In some preferred embodiments the faucet has the general appearance of a conventional human use indoor sink faucet. In various embodiments, the pet water valve, when actuated, provides a flow of water at a pre-determined rate of flow. And in some embodiments the pet water valve, when actuated, provides a flow of water at a pre-determined rate of flow that can be adjusted by a human user.

In certain preferred embodiments a pet is able to operate the pet valve actuator by making physical contact therewith. In some embodiments the pet valve actuator includes a lever that can be mechanically operated by a pet. And in some of these embodiments the lever is concentric with and extends outward from within the pet water outlet.

In other preferred embodiments the pet water valve is non-contactingly actuated. In some embodiments the pet valve actuator includes a sensor that is able to non-contactingly sense the presence of a pet. And in some of these embodiments the sensor is able to emit and detect sensing energy that is infra-red, optical, LASER, microwave, acoustic and/or ultra-sonic. In various of these embodiments the sensor is integral with the spout. And in certain of these embodiments the sensor is inconspicuously incorporated into the spout.

Preferred embodiments further include a pet flow deactivator that is able to prevent a flow of water from the pet water outlet when water is flowing from the human use water outlet. In some of these embodiments the pet flow deactivator includes a water flow sensor that is able to detect a flow of water to the human use water outlet.

Various preferred embodiments further include a training mode selector that can be activated by a user so as to cause water to flow continuously from the pet water outlet without requiring actuation of the pet water valve by a pet, thereby conditioning a pet to expect water to flow from the pet water outlet, and providing an opportunity for a pet to learn to drink therefrom.

In certain preferred embodiments the faucet includes two pet water valves that are connected to the pet water outlet, the pet water valves being connectable to separate sources of water that supply water at different temperatures, the pet valve actuator being able to actuate both pet water valves so as to supply water at a desired temperature to the pet water outlet. And in some of these preferred embodiments the desired temperature can be adjusted by a human user.

In certain preferred embodiments the faucet is configured so as to exclude the possibility of water flowing simultaneously from both the human use water outlet and the pet water outlet. And in some preferred embodiments the pet water outlet is inconspicuously incorporated into the spout.

### BRIEF DESCRIPTION OF THE DRAWINGS

The invention will be more fully understood by reference to the detailed description, in conjunction with the following figures, wherein:

FIG. 1A is a perspective drawing of a preferred embodiment that includes a remote pet sensor, a human use water outlet, and a pet water outlet, all incorporated into the faucet housing;

FIG. 1B is a close-up view of the distal end of the faucet housing of FIG. 1A, showing the distal ends of the remote sensor and the pet water outlet integrated into the distal end of the faucet housing;

FIG. 2A is a perspective drawing of the embodiment of FIG. 1A, wherein a human use water valve has been activated and water is flowing out of the human use water outlet;

FIG. 2B is a perspective view showing a flow of human use water in an embodiment similar to the embodiment of FIG. 2A, except that a flow of water from the human use water outlet and a flow of water from the pet water outlet emerge from a common outlet;

FIG. 2C is a perspective view showing a flow of pet water in the embodiment of FIG. 2B;

FIG. 3A is a perspective view of the embodiment of FIG. 1A, showing a cat being detected by the remote sensor;

FIG. 3B is a perspective view of the embodiment of FIG. 3A showing the cat drinking water flowing from the pet water outlet due to detection of the cat by the remote sensor;

FIG. 4A is a side view of the faucet of FIG. 1A, showing the remote sensor and human and pet water channels incorporated in the faucet housing, as well as a mechanically activated human use water valve and an electronically activated pet water valve with a user-adjustable timer;

FIG. 4B is a functional diagram of an embodiment that includes two pet water valves connected to two sources of water at different temperatures, so as to supply water to the pet water outlet at a desired temperature;

FIG. 5A is a perspective view of an embodiment similar to FIG. 1A, but including a mechanically activated pet water valve instead of a remote sensor;

FIG. 5B is a perspective view of the embodiment of FIG. 5A, wherein a human use water valve has been activated and water is flowing out of the human use water outlet;

FIG. 5C is a close up side view of the pet water outlet and mechanically operated pet valve actuator of FIG. 5B, shown in an inactive state;

FIG. 5D is a close up side view of the pet water outlet and mechanically operated pet valve actuator of FIG. 5B, shown in an activated state with water flowing therefrom; and

FIG. 5E is a perspective view of the embodiment of FIG. 5A, wherein a cat has activated the pet water valve with its head, and is drinking therefrom.

### DETAILED DESCRIPTION OF PREFERRED EMBODIMENTS

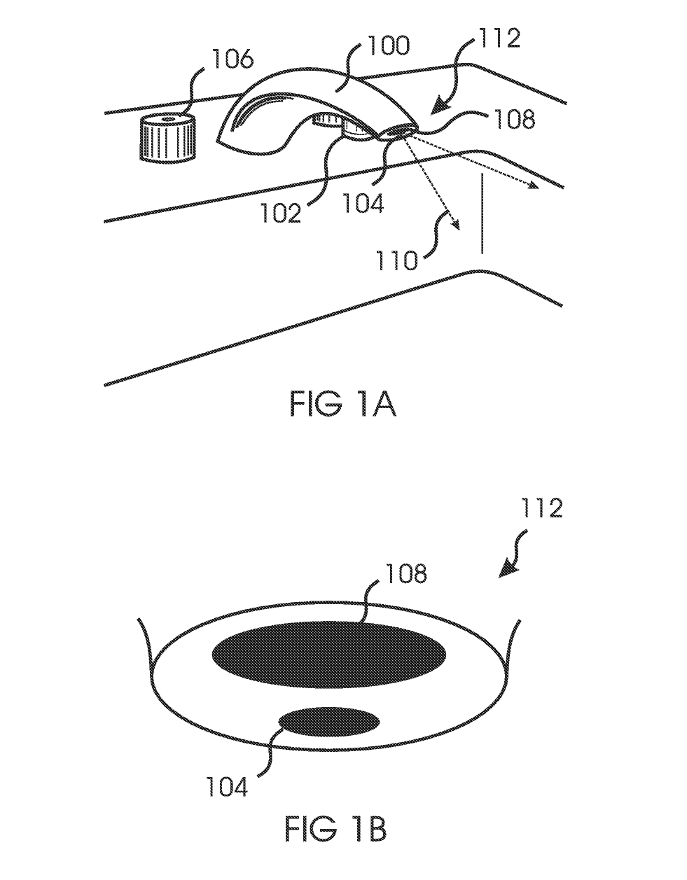

With reference to FIG. 1A, the present invention is a faucet that is adapted for use by both humans and indoor pets. The faucet housing 100 resembles a typical human faucet housing, but includes two water outlets, a human use water outlet 102 and a pet water outlet 104, both of which are integral with the housing 100. In the embodiment of FIG. 1A, the human use water outlet 102 and the pet water outlet 104 are separate, while in other embodiments water flows from the same outlet for both humans and pets.

A pair of conventional, manually controlled water valves 106 is provided for control of water flowing from the human use outlet 102. As with conventional human water faucets, the human use water valves 106 allow a human user to control the temperature and flow rate of a stream of water flowing from the human use water outlet 102, and typically allow a maximum flow of water that would be above the ideal flow rate for a pet.

The embodiment of FIG. 1A includes a remote electronic sensor 108 inconspicuously incorporated into the distal end of the faucet housing 100. The remote sensor 108 emits a sensing radiation 110, such as infra-red light, microwaves, or another form of sensing radiation well known in the art, and detects reflection of the radiation 110 so as to sense the presence and/or the motion of a pet near the faucet housing 100. The human use water outlet 102 is located near the distal end 112 of the faucet housing 100, and is configured so as to direct a stream of human use water downward from the housing 100.

FIG. 1B presents a close-up view of the distal end 112 of the faucet housing 100 of FIG. 1A, showing the remote electronic sensor 108 and the pet water outlet 104.

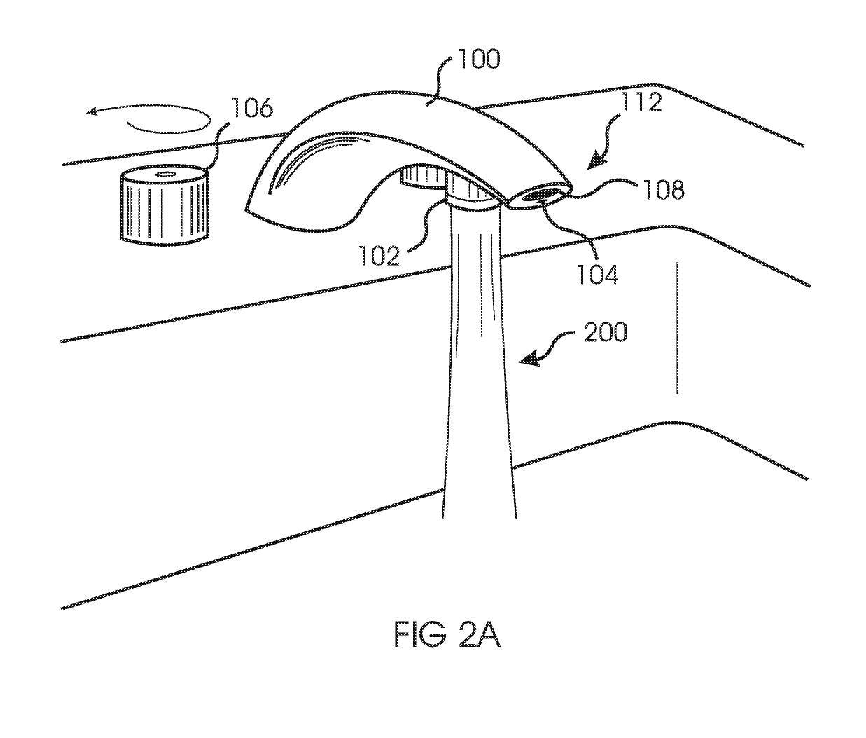

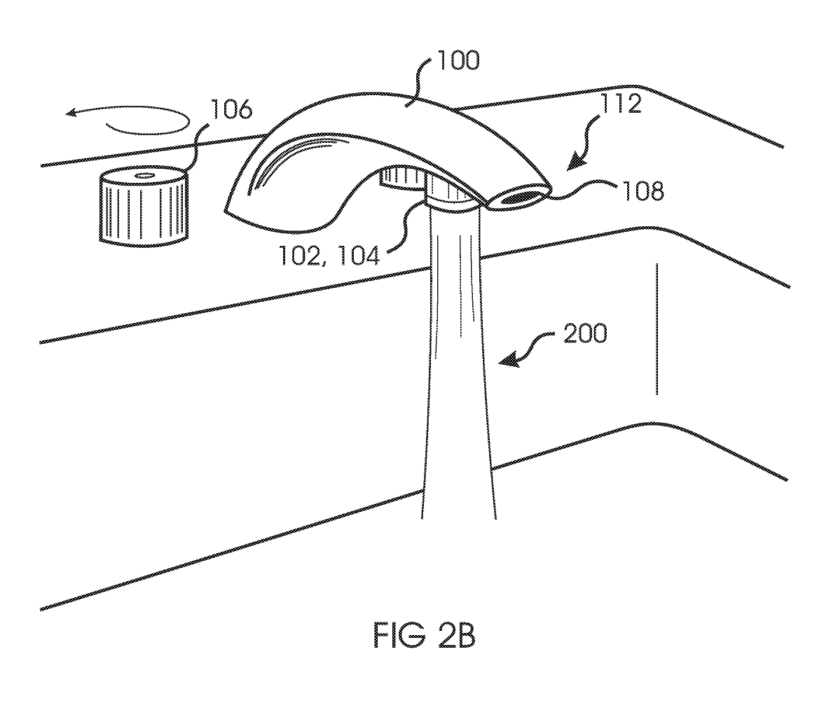

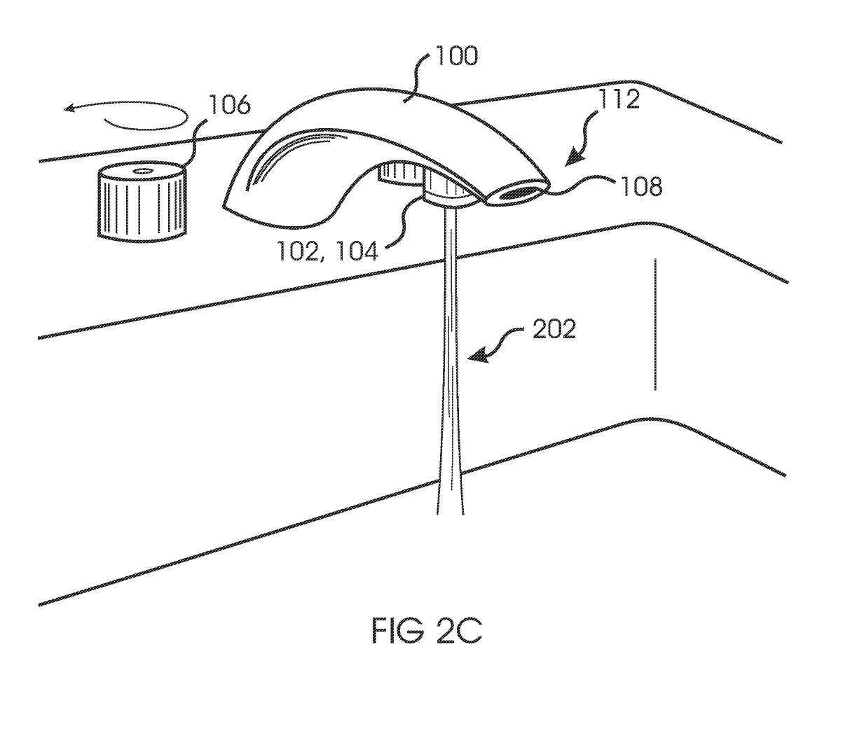

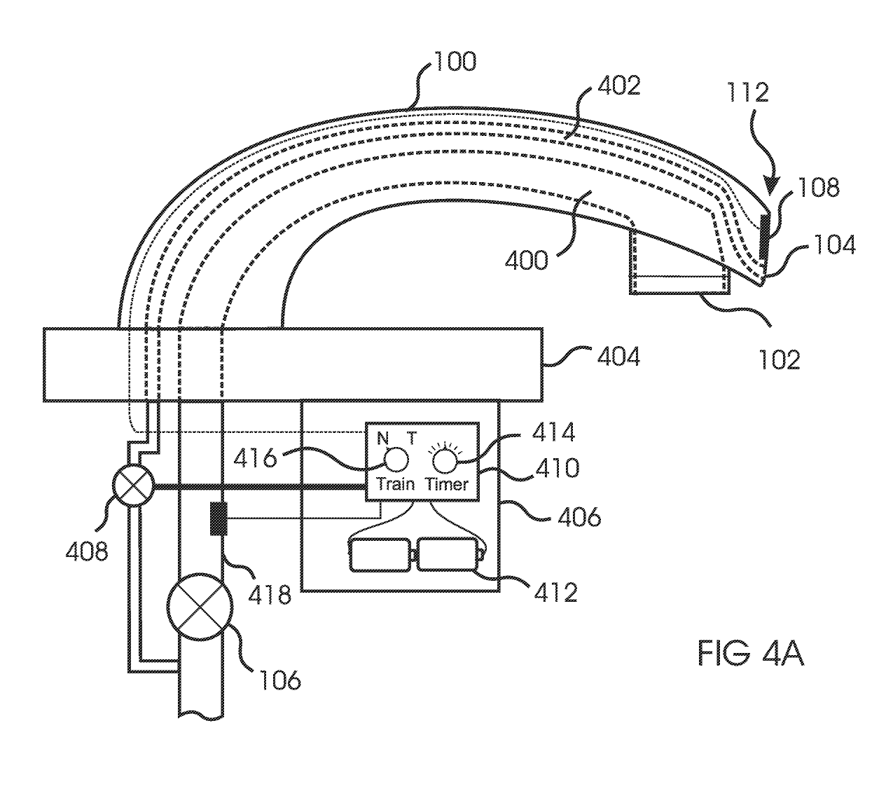

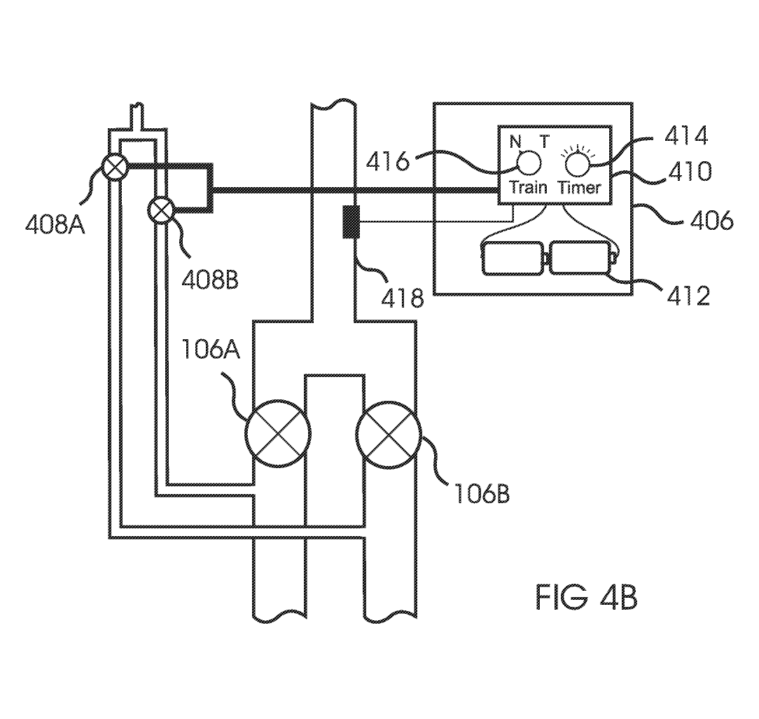

FIG. 2A illustrates human use of the embodiment of FIG. 1A. One of the human use water valves 106 has been rotated, causing a strong flow of water 200 to emerge from the human use water outlet 102. A flow sensor (item 418 of FIG. 4A) senses the flow of water toward the human use water outlet and causes the remote sensor 108 to be disabled, thereby preventing a human user from inadvertently causing water to flow from the pet water outlet 104.

FIG. 2B and FIG. 2C illustrate an embodiment similar to the embodiment of FIG. 2A, except that the human use water outlet 102 and the pet water outlet 104 are coincident, such that a flow of water 200 from the human use water outlet 102 and a flow of water 202 from the pet water outlet 104 emerge from a common outlet 102, 104.

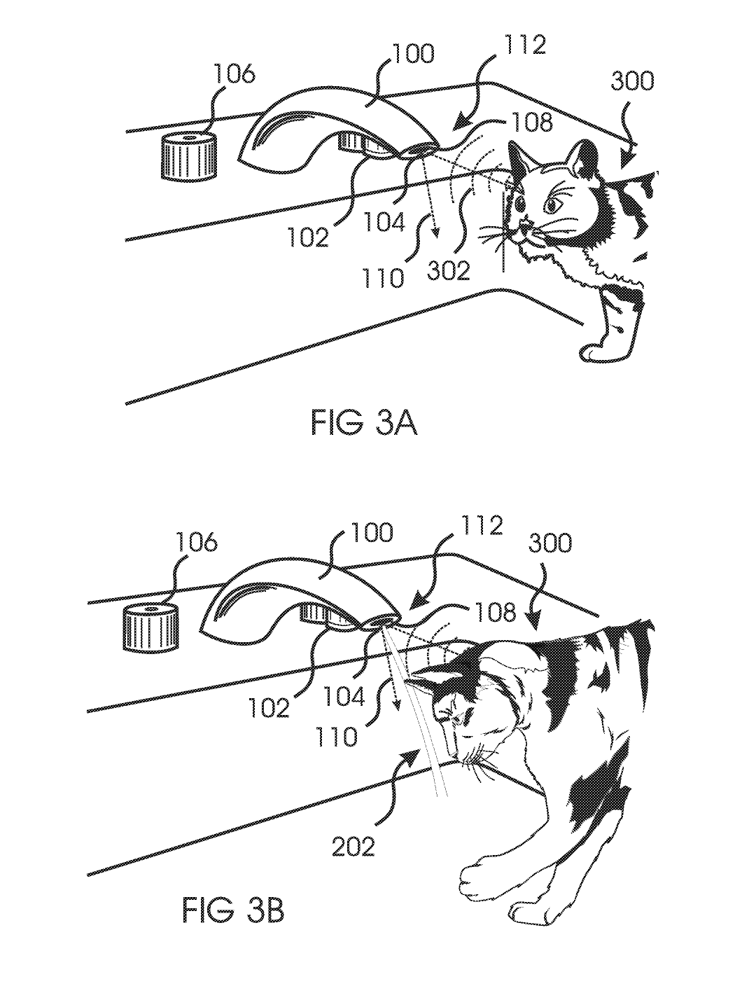

FIG. 3A and FIG. 3B illustrate pet use of the embodiment of FIG. 1A. In FIG. 3A a cat 300 has moved near the remote sensor 108, such that a portion 302 of the sensing radiation 110 emitted by the sensor 108 is being reflected back and detected by the sensor 108. In FIG. 3B the remote sensor has activated the pet water valve (item 408 in FIG. 4A), causing water to flow 202 from the pet water outlet 104 at a rate that is appropriate for allowing a cat to drink.

FIG. 4A presents a cross sectional side view of the faucet of FIG. 1A. In FIG. 4A it can be seen that a human use water channel 400 and a pet water channel 402 are located within the faucet housing 100 so as to deliver water to the human use water outlet 102 and the pet water outlet 104 respectively. Below the counter top 404 to which the faucet is mounted there is a pet water valve system 406 that includes a pet water valve 408 and an electronic valve controller 410 powered by 412 batteries. In similar embodiments a conventional AC electrical cord is used to provide AC power from a wall socket.

The electronic valve controller 410 includes a timer 414 that can be adjusted by a user to specify how long pet water should continue to flow after a pet is no longer detected by the remote sensor 108. The electronic valve controller 410 also includes a training mode selector 416 that allows a user to switch the electronic valve controller 410 into a training mode that causes water to flow continuously from the pet water outlet 104 without requiring detection of a pet by the remote sensor 108. In similar embodiments, the training mode selector controls a separate training valve that by-passes the pet water valve 408. The pet training mode teaches a pet to anticipate that water can be obtained from the pet water outlet 104, and provides an opportunity for a pet to learn to drink from the pet water outlet 104.

A flow sensor 418 is incorporated into the human use water channel 400. When a flow of water in the human use water channel 400 is detected by the flow sensor 418, the electronic valve controller 410 is deactivated, so that the remote sensor 108 does not emit sensing energy and does not cause water to flow inadvertently from the pet water outlet 104.

FIG. 4B presents a functional diagram of a preferred embodiment that includes separate sources of hot and cold water controlled by human use valves 106A and 106B respectively. The embodiment of FIG. 4B includes two pet water valves 408A, 408B, one of which 408A controls a flow of water from the source of hot water and the other of which 408B controls a flow of water from the source of cold water. Both of the pet water valves 408A, 408B are controlled by the electronic valve controller 410. A user settable adjustment (not shown) allows a user to specify a desired mixture of hot and cold water, so that when the pet valves are activated water 202 is delivered to the pet water outlet 104 at a desired temperature.

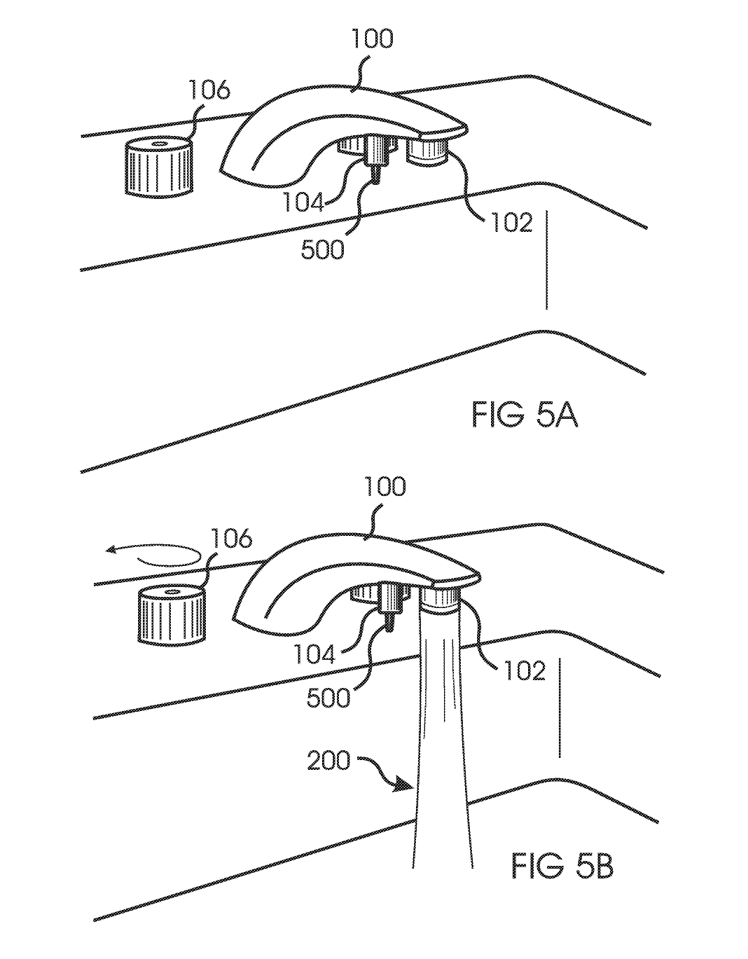

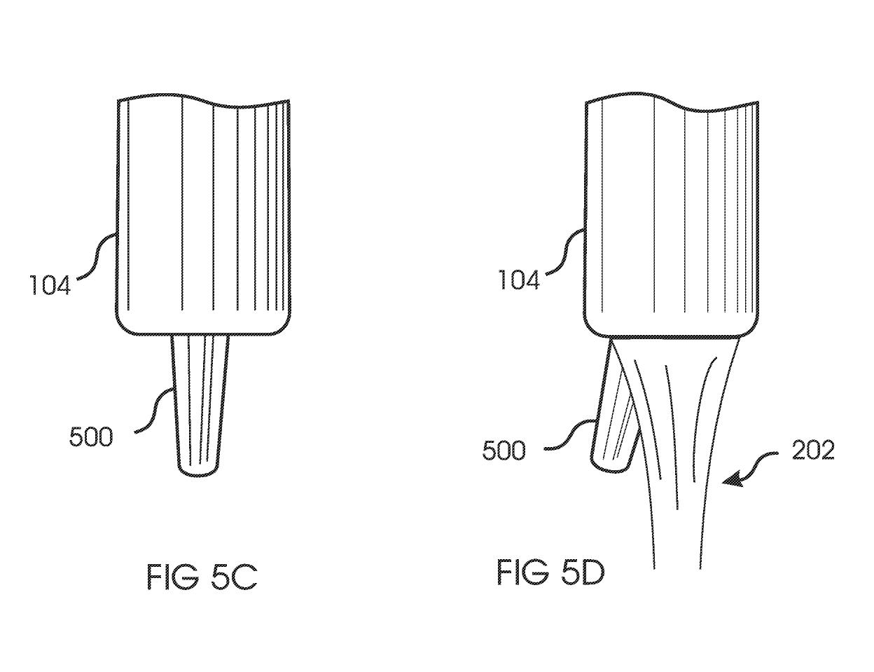

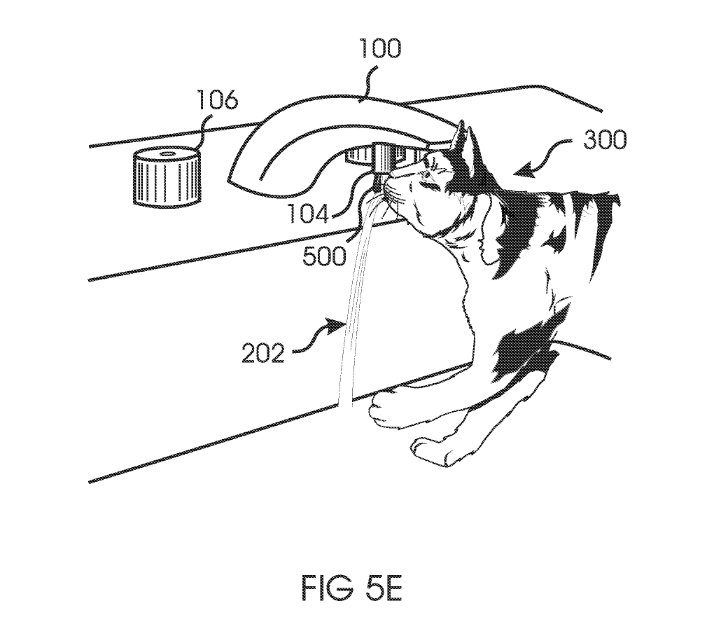

FIG. 5A illustrates an embodiment similar to the embodiment of FIG. 1A, except that the pet valve actuator is a lever 500 that mechanically activates the pet water valve. In this embodiment, the lever 500 is concentrically incorporated into the pet water outlet 104 and extends beyond the pet water outlet 104, thereby allowing a pet to simultaneously deflect the lever 500 and drink water flowing from the pet water outlet 104. The pet water outlet 104 and lever 500 are located beneath the faucet housing 100, and do not interfere with the human use water outlet 102 because they are closer to the proximal end of the faucet housing 100.

FIG. 5B illustrates human use of the embodiment of FIG. 5A. One of the human use water valves 106 has been rotated, causing a strong flow of water 200 to emerge from the human use water outlet 102.

FIG. 5C and FIG. 5D present close-up side views of the pet water outlet 104 and lever 500 of FIG. 5A. As shown in FIG. 5C, when the lever 500 is not deflected, the pet valve (408 in FIG. 4A) is closed, and water does not flow from the pet water outlet 104. FIG. 5D presents a close-up side view of the pet water outlet 104 and lever 500 of FIG. 5C with the lever 500 deflected and water 202 flowing from the pet water outlet 104.

FIG. 5E illustrates use of the embodiment of FIG. 5A by a cat 300 that has learned to use the invention. The cat 300 is using its head to push on the lever 500, causing water to flow from the pet water outlet 104 and allowing the cat 300 to drink therefrom. In the embodiment of FIG. 5E, the water only flows when the lever 500 is pushed. In other embodiments, the lever 500 is mechanically configured to remain activated for several seconds before springing back to its “off” position. This allows a pet to push on the lever 500 with a paw or with any other body part and then to drink from the pet water outlet 104 while the water continues to flow. In similar embodiments, the mechanical pet valve actuator 500 and the pet water outlet 104 are physically separated from each other.

Other modifications and implementations will occur to those skilled in the art without departing from the spirit and the scope of the invention as claimed. Accordingly, the above description is not intended to limit the invention except as indicated in the following claims.

What is claimed is:

1. An indoor sink faucet adapted for use by both humans and pets, the faucet comprising:
a spout;
a human use water outlet integral with the spout;
a pet water outlet integral with the spout;
a human use water valve, the human use water valve being:
connected to the human use water outlet;
connectable to a source of water; and
able to be activated by a human user so as to provide a flow of water from the human use water outlet;
a pet water valve, the pet water valve being:
connected to the pet water outlet;
connectable to the source of water; and
able to be activated so as to provide a flow of water from the pet water outlet; and
a pet valve actuator cooperative with the pet water valve and configured so as to enable actuation of the pet water valve by a pet.

2. The faucet of claim 1, wherein the flow of water from the human use water outlet and the flow of water from the pet water outlet emerge from a common outlet.

3. The faucet of claim 1, wherein the faucet has the general appearance of a conventional human use indoor sink faucet.

4. The faucet of claim 1, wherein the pet water valve, when actuated, provides a flow of water at a pre-determined rate of flow.

5. The faucet of claim 1, wherein the pet water valve, when actuated, provides a flow of water at a pre-determined rate of flow that can be adjusted by a human user.

6. The faucet of claim 1, wherein a pet is able to operate the pet valve actuator by making physical contact therewith.

7. The faucet of claim 1, wherein the pet valve actuator includes a lever that can be mechanically operated by a pet.

8. The faucet of claim 7, wherein the lever is concentric with and extends outward from within the pet water outlet.

9. The faucet of claim 1, wherein the pet water valve is non-contactingly actuated.

10. The faucet of claim 1, wherein the pet valve actuator includes a sensor that is able to non-contactingly sense the presence of a pet.

11. The faucet of claim 10, wherein the sensor is able to emit and detect sensing energy that is at least one of:
infra-red;
optical;
LASER;
microwave;
acoustic; and
ultra-sonic.

12. The faucet of claim 10, wherein the sensor is integral with the spout.

13. The faucet of claim 10, wherein the sensor is inconspicuously incorporated into the spout.

14. The faucet of claim 1, further comprising a pet flow deactivator that is able to prevent a flow of water from the pet water outlet when water is flowing from the human use water outlet.

15. The faucet of claim 14, wherein the pet flow deactivator includes a water flow sensor that is able to detect a flow of water to the human use water outlet.

16. The faucet of claim 1, further comprising a training mode selector that can be activated by a user so as to cause water to flow continuously from the pet water outlet without requiring actuation of the pet water valve by a pet, thereby conditioning a pet to expect water to flow from the pet water outlet, and providing an opportunity for a pet to learn to drink therefrom.

17. The faucet of claim 1, wherein the faucet includes two pet water valves that are connected to the pet water outlet, the pet water valves being connectable to separate sources of water that supply water at different temperatures, the pet valve actuator being able to actuate both pet water valves so as to supply water at a desired temperature to the pet water outlet.

18. The faucet of claim 17, wherein the desired temperature can be adjusted by a human user.

19. The faucet of claim 1, wherein the faucet is configured so as to exclude the possibility of water flowing simultaneously from both the human use water outlet and the pet water outlet.

20. The faucet of claim 1, wherein the pet water outlet is inconspicuously incorporated into the spout.
